(19) United States
(12) Patent Application Publication
(10) Pub. No.: US 2026/0279634 A1
(43) Pub. Date: Sep. 17, 2026

(54) Magnetic Fluid Composition

(71) Applicant: SEIKO EPSON CORPORATION, Tokyo (JP)

(72) Inventors: Daisuke ISHIHARA, Matsumoto (JP); Takeshi YANO, Fujimi (JP); Shigeki KAWADA, Shiojiri (JP)

(21) Appl. No.: 19/564,707

(22) Filed: Mar. 12, 2026

(30) Foreign Application Priority Data
Mar. 13, 2025 (JP) 2025-040244

(51) Int. Cl. H01F 1/44

(52) U.S. Cl. CPC H01F 1/44

(57) ABSTRACT

A magnetic fluid composition includes a dispersoid and a dispersion medium, wherein the dispersoid contains metal magnetic particles having an average particle diameter of 5 μm or more and 120 μm or less and silica particles having an average particle diameter of 10 nm or more and 500 nm or less, the dispersion medium contains an ionic liquid and an additive containing a polymer or oligomer having a urea structure, the content ratio of the silica particles with respect to a total amount of the magnetic fluid composition is 0.01 mass % or more and 5 mass % or less, and the content ratio of the additive with respect to a total amount of the silica particles is 50 mass % or more and 200 mass % or less.

The present application is based on, and claims priority from JP Application Serial Number 2025-040244, filed Mar. 13, 2025, the disclosure of which is hereby incorporated by reference herein in its entirety.

### BACKGROUND

### 1. Technical Field

The present disclosure relates to a magnetic fluid composition.

### 2. Related Art

A magneto rheological fluid (also referred to as a “MR fluid”) is a fluid in which metal magnetic particles are dispersed in a dispersion medium such as mineral oil or silicone oil. When a magnetic field is applied to the magneto rheological fluid, the metal magnetic particles are magnetized and arranged in a magnetic field direction, forming chain-shaped clusters, which changes the viscosity of the fluid. A formation strength of the chain-shaped clusters depends on a magnitude of the magnetic field to be applied, and the viscosity can be varied by changing the magnitude of the magnetic field.

When the magnetic field is removed, the magnetization of the metal magnetic particles is released, the chain-shaped clusters returns to an original non-oriented state, and the viscosity also returns to an original state. The viscosity of the fluid can be adjusted by repeating application and removal of the magnetic field to or from the magneto rheological fluid or changing the strength of the magnetic field. Therefore, the magneto rheological fluid is considered for use in a variety of fields, including control devices such as linear dampers and rotary dampers, and braking devices such as brakes and clutches.

A high braking force is required for the magneto rheological fluid used in the braking device. Furthermore, the metal magnetic particles contained in the magneto rheological fluid are likely to settle due to their specific gravity, and therefore dispersion stability becomes an issue.

For example, JP-A-2024-154198 discloses a magneto rheological fluid in which, to improve the dispersion stability of magnetic metal particles, a main component of a dispersion medium contained in the magnetic viscous fluid has a specified boiling point, and the distance between the HSP coordinates of the magnetic metal particles and those of the main component of the dispersion medium is 13 or less.

JP-A-2024-154198 is an example of the related art.

With the expansion of the application range of magneto rheological fluid, a magnetic fluid composition that achieves both high braking force and dispersion stability is required.

### SUMMARY

The present disclosure has been made in view of the above circumstances, and an object thereof is to provide a magnetic fluid composition that can achieve both high braking force and dispersion stability.

That is, the present disclosure includes the following aspects.

[1] A magnetic fluid composition includes a dispersoid and a dispersion medium, in which the dispersoid contains metal magnetic particles having an average particle diameter of 5 μm or more and 120 μm or less and silica particles having an average particle diameter of 10 nm or more and 500 nm or less, the dispersion medium contains an ionic liquid and an additive containing a polymer or oligomer having a urea structure, the content ratio of the silica particles with respect to a total amount of the magnetic fluid composition is 0.01 mass % or more and 5 mass or less, and the content ratio of the additive with respect to a total amount of the silica particles is 50 mass % or more and 200 mass % or less.

[2] The magnetic fluid composition according to [1], in which the ionic liquid contains a cationic group and an anionic group, the cationic group is one or more selected from the group including a quaternary ammonium ion, an imidazolium ion, a pyridinium ion, and a phosphonium ion, and the anionic group is one or more selected from the group including a tetrafluoroborate ion, a hexafluorophosphate ion, a trispentafluoroethyltrifluorophosphate ion, and a bis(trifluoromethanesulfonyl)amide ion.

[3] The magnetic fluid composition according to [2], in which the cationic group is a cation of any of the following (A)-1, (A)-2, (B)-1, (C)-1, and (D)-1.

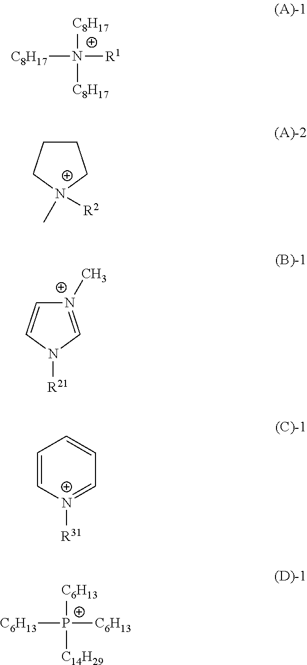

[In the above formula, R¹ represents a linear or branched alkyl group having 1 to 10 carbon atoms, R² represents a linear or branched alkyl group having 1 to 5 carbon atoms, R²¹ represents an alkyl group having 4 to 6 carbon atoms, and R³¹ represents an alkyl group having 4 to 8 carbon atoms.]

[4] The magnetic fluid composition according to any one of [1] to [3], in which the material of the metal magnetic particles is permendur.

[5] The magnetic fluid composition according to any one of [1] to [4], in which the magnetic fluid composition has a yield stress of 15 kPa or more when being applied with a magnetic field of 1.0 T.

[6] The magnetic fluid composition according to any one of [1] to [5], in which the magnetic fluid composition has a boiling point of 250° C. or higher and a freezing point of 0° C. or lower.

According to the present disclosure, it is possible to provide the magnetic fluid composition capable of achieving both high braking force and dispersion stability.

### DESCRIPTION OF EMBODIMENTS

### Magnetic Fluid Composition

The present disclosure is a magnetic fluid composition including a dispersoid and a dispersion medium. Each component will be described below.

### Dispersoid

The dispersoid contains metal magnetic particles and silica particles.

### Metal Magnetic Particles

The metal magnetic particles in the present specification are particles containing a metal material having a volume average particle diameter of 5 μm or more and 120 μm or less and exhibiting paramagnetism as a constituent material. The metal magnetic particles are a paramagnetic material as a whole. A material constituting the magnetic particles contains a metal element, and preferably contains at least one metal element selected from the group including Fe, Ni, and Co.

The above metal element may be contained in the metal magnetic particles as a magnetic alloy, a magnetic metal oxide, a magnetic metal nitride, or a magnetic metal carbide.

The materials constituting the metal magnetic particles may contain an element other than Fe, Ni, and Co, and specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, and N.

Specific examples of the materials constituting the metal magnetic particles include alloys such as an Fe—Co-based alloy (preferably permendur), an Fe—Ni-based alloy (preferably permalloy), an Fe—Zr-based alloy, an Fe—Mn-based alloy, an Fe—Si-based alloy, an Fe—Al-based alloy, a Ni—Mo-based alloy (preferably supermalloy), an Fe—Ni—Co-based alloy, an Fe—Si—Cr-based alloy, an Fe—Si—B-based alloy, an Fe—Si—Al-based alloy (preferably sendust), an Fe—Si—B—C-based alloy, an Fe—Si—B—Cr-based alloy, an Fe—Si—B—Cr—C-based alloy, an Fe—Co—Si—B-based alloy, an Fe—Si—B—Nb-based alloy, an Fe nano crystal alloy, an Fe-based amorphous alloy, and a Co-based amorphous alloy, and ferrite such as spinel ferrite (preferably Ni—Zn-based ferrite or Mn—Zn-based ferrite) and hexagonal ferrite (preferably barium ferrite). The above alloy may be an amorphous alloy.

Among the metal magnetic particles, the Fe—Co-based alloy is preferred, and the permendur is more preferred.

The metal magnetic particles may be used alone or in combination of two or more types of metal magnetic particles having different materials.

A content ratio of the metal magnetic particles in the magnetic fluid composition is, for example, 65 mass or more and 99 mass % or less and 70 mass % or more and 90 mass % or less with respect to a total mass of the magnetic fluid composition.

When two or more types of metal magnetic particles are contained, the above content ratio is a total content ratio of two or more types of metal composite particles.

### Silica Particles

In a general magnetic fluid composition, the metal magnetic particles are dispersed in a dispersion medium such as mineral oil or silicone oil.

Because the difference in specific gravity between a general dispersion medium such as mineral oil or silicone oil and the metal magnetic particles in the magnetic fluid composition is large, the metal magnetic particles are likely to settle.

Fine particles in a liquid diffuse into the dispersion medium due to random Brownian motion. Further, fine particles in the dispersion medium settle by gravity, but when the diffusion effect due to Brownian motion is greater than a settling velocity of the particles, the minute particles does not settle and can maintain a diffused state.

Silica particles having a volume average particle diameter of 10 nm or more and 500 nm or less are less likely to settle in the dispersion medium due to Brownian motion and are likely to maintain a diffused state. Since the diffused silica particles inhibit the settling of the metal magnetic particles, the metal magnetic particles can be maintained in a dispersed state.

The volume average particle diameter of the silica particles is preferably 15 nm or more and 500 nm or less.

When the volume average particle diameter of the silica particles is less than or equal to the above upper limit value, the diffusion effect due to Brownian motion is greater than the settling velocity of the particles, and the silica particles are maintained in a diffused state.

When the volume average particle diameter of the silica particles is more than or equal to the above lower limit value, settling of the metal magnetic particles is likely to be inhibited.

The content ratio of the silica particles with respect to the total amount of the magnetic fluid composition is 0.01 mass % or more and 5 mass % or less, preferably 0.1 mass % or more and 3 mass % or less, and more preferably 0.5 mass % or more and 2 mass % or less.

When the content ratio of the silica particles is more than or equal to the above lower limit value, settling of the metal magnetic particles is likely to be inhibited.

When the content ratio of the nonmagnetic particles is equal to or less than the above lower limit value, a dispersion state of the silica particles is likely to be maintained.

In the present embodiment, the volume average particle diameter of the metal magnetic particles or the silica particles can be determined based on a cumulative distribution curve obtained from a volume-based particle size distribution measured by a laser diffraction/scattering method.

Specifically, in the cumulative distribution curve, a particle diameter D50 (median diameter) at which a cumulative value from a small diameter side is 50% is the average particle diameter of the metal magnetic particles or the silica particles. As an apparatus for measuring the particle size distribution by the laser diffraction/scattering method, for example, MT3300 series manufactured by MicrotracBEL Corp. may be used.

### Dispersion Medium

The dispersion medium contains an ionic liquid and an additive containing a polymer or oligomer containing a urea structure (—NH—CO—NH—). In one aspect of the present disclosure, the dispersion medium preferably includes the ionic liquid and the additive.

### Ionic Liquid

The ionic liquid includes a cationic group and an anionic group.

The cationic group is one or more selected from the group including a quaternary ammonium ion, an imidazolium ion, a pyridinium ion, and a phosphonium ion.

The anionic group is one or more selected from the group including a tetrafluoroborate ion, a hexafluorophosphate ion, a trispentafluoroethyltrifluorophosphate ion, and a bis(trifluoromethanesulfonyl)amide ion.

It was found that the ionic liquid including a combination of the above cationic group and anionic group does not evaporate even at 250° C. or higher and remains liquid even at 0° C. or lower.

The ionic liquid has a higher affinity with the metal magnetic particles than that with the mineral oil, and using the ionic liquid in the dispersion medium makes it difficult for the magnetic fluid composition to separate.

The cationic group and the anionic group will be described below.

### Quaternary Ammonium Ion

Examples of the quaternary ammonium ion include a cation represented by the following formula (A).

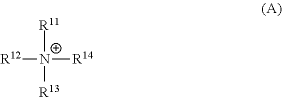

[In formula (A), R¹¹ to R¹⁴ each independently represent a linear or branched alkyl group having 1 to 20 carbon atoms. R¹¹ to R¹⁴ may be bonded to each other to form a ring.]

Examples of the linear alkyl group of R¹¹ to R¹⁴ include linear alkyl groups having 1 to 20 carbon atoms. Specific examples thereof include a methyl group, an ethyl group, a propyl group, a butyl group, a pentyl group, a hexyl group, a heptyl group, an octyl group, a nonyl group, a decanyl group, an undecyl group, a dodecyl group, a tridecyl group, a tetradecyl group, a pentadecyl group, a hexadecyl group, a heptadecyl group, an octadecyl group, a nonadecyl group, and an icosyl group.

Examples of the branched alkyl group of R¹¹ to R¹⁴ include branched alkyl groups having 3 to 20 carbon atoms. Specific examples thereof include a 1-methylethyl group, a 1-methylpropyl group, a 2-methylpropyl group, a 1-methylbutyl group, a 2-methylbutyl group, a 3-methylbutyl group, a 1-ethylbutyl group, a 2-ethylbutyl group, a 1-methylpentyl group, a 2-methylpentyl group, a 3-methylpentyl group, and a 4-methylpentyl group.

When R¹¹ to R¹⁴ are bonded to each other to form a ring, examples of the formed ring include a cyclopropyl group, a cyclobutyl group, a cyclopentyl group, a cyclohexyl group, a cycloheptyl group, a cyclooctyl group, a cyclodecyl group, and a cyclododecyl group.

Specific examples of the quaternary ammonium ion include tetraethyl ammonium, tetramethyl ammonium, tetrapropyl ammonium, tetrabutyl ammonium, and tetrapentyl ammonium.

As the quaternary ammonium ion, a cation represented by the following (A)-1 or (A)-2 is more preferable.

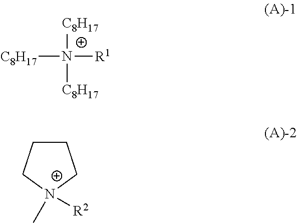

In (A)-1, R¹ is a linear or branched alkyl group having 1 to 10 carbon atoms.

In (A)-2, R² is a linear or branched alkyl group having 1 to 5 carbon atoms.

### Imidazolium Ion

Examples of the imidazolium ion include a cation represented by the following formula (B).

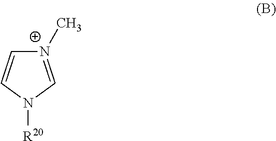

[In Formula (B), R²⁰ is a linear or branched alkyl group having 1 to 20 carbon atoms.]

The description related to the linear or branched alkyl group having 1 to 20 carbon atoms of R²⁰ in Formula (B) is the same as the description related to the linear or branched alkyl group having 1 to 20 carbon atoms of R¹¹ to R¹⁴ in above Formula (A).

As R²⁰, an alkyl group having 1 to 10 carbon atoms is preferred, and an alkyl group having 2 to 8 carbon atoms is furthermore preferred.

As the imidazolium ion, a cation represented by the following formula (B)-1 is more preferable.

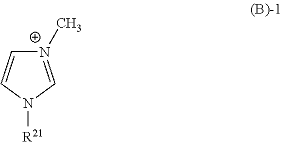

[In Formula (B)-1, R²¹ is an alkyl group having 4 to 8 carbon atoms.]

Examples of R²¹ include an n-butyl group, a sec-butyl group, an isobutyl group, a tert-butyl group, a pentyl group, a hexyl group, a heptyl group, and an octyl group.

### Pyridinium Ion

Examples of the pyridinium ion include a cation represented by the following formula (C).

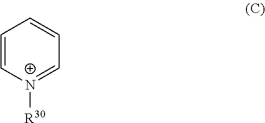

[In Formula (C), R³⁰ is a linear or branched alkyl group having 1 to 20 carbon atoms.]

The description related to the linear or branched alkyl group having 1 to 20 carbon atoms of R³⁰ in Formula (C) is the same as the description related to the linear or branched alkyl group having 1 to 20 carbon atoms of R¹¹ to R¹⁴ in above Formula (A).

As R³⁰, an alkyl group having 1 to 10 carbon atoms is preferred, and an alkyl group having 2 to 8 carbon atoms is furthermore preferred.

As the pyridinium ion, a cation represented by the following formula (C)-1 is preferable.

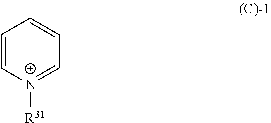

[In Formula (C)-1, R³¹ is an alkyl group having 4 to 6 carbon atoms.]

Examples of R³¹ include an n-butyl group, a sec-butyl group, an isobutyl group, a tert-butyl group, a pentyl group, and a hexyl group.

### Phosphonium Ion

Examples of the phosphonium ion include a cation represented by the following formula (D).

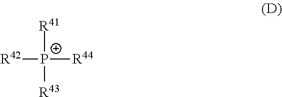

[In formula (D), R⁴¹ to R⁴⁴ each independently represent a linear or branched alkyl group having 1 to 20 carbon atoms. R⁴¹ to R⁴⁴ may be bonded to each other to form a ring.]

The description related to the linear or branched alkyl group having 1 to 20 carbon atoms of R⁴¹ to R⁴⁴ in Formula (D) is the same as the description related to the linear or branched alkyl group having 1 to 20 carbon atoms of R¹¹ to R¹⁴ in above Formula (A).

As R⁴¹ to R⁴⁴, an alkyl group having 2 to 18 carbon atoms is preferred, and an alkyl group having 4 to 16 carbon atoms is furthermore preferred.

Examples of the phosphonium ion include tetrabutylphosphonium, tetrapropylphosphonium, tetraethylphosphonium, tetramethylphosphonium, and hexadecyltributylphosphonium.

The cation is preferably a cation of any of the following (A)-1, (A)-2, (B)-1, (C)-1, and (D)-1.

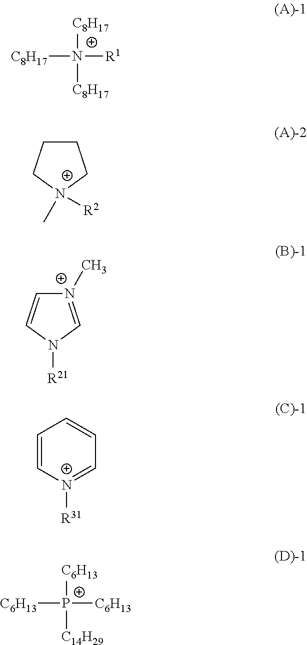

[In the above formula, R¹ represents a linear or branched alkyl group having 1 to 10 carbon atoms, R² represents a linear or branched alkyl group having 1 to 5 carbon atoms, R²¹ represents an alkyl group having 4 to 6 carbon atoms, and R³¹ represents an alkyl group having 4 to 8 carbon atoms.]

The anionic group is one or more selected from the group including a tetrafluoroborate ion, a hexafluorophosphate ion, a trispentafluoroethyltrifluorophosphate ion, and a bis(trifluoromethanesulfonyl)amide ion.

A content ratio of the ionic liquid with respect to the total amount of the magnetic fluid composition is preferably 5 mass % or more and 30 mass % or less, and more preferably 10 mass % or more and 20 mass % or less.

When the content ratio of the ionic liquid is in the above range, the dispersion state of the silica particles is likely to be maintained.

### Additive

As the additive containing a polymer or oligomer having a urea structure, an additive generally called rheology control agents can be used. As such additives, urea-based rheology control agents such as BYK-410 and BYK-411 can be employed.

The silica particles constituting the dispersion medium have silanol groups on the particle surface, and form a three-dimensional structure by hydrogen bonding. When a dispersant containing the above additive is used in combination, the three-dimensional structure formed by the silica particles is enhanced. Such a magnetic fluid composition is less likely to settle metal magnetic particles having a large volume average particle diameter, and can achieve both high braking force and dispersion stability.

Although rheology control agents themselves are known additives, through investigations described in the present disclosure, it has been found that when a material containing a polymer or an oligomer having a urea structure is used among rheology control agents, metal magnetic particles having a large volume average particle diameter are less likely to settle.

The reason for this is presumed to be as follows.

Polar groups in the urea structure, such as carbonyl and amino groups, coordinate with silica particles, forming pseudo-crosslinks between the particles and thereby reinforcing the silica particle network. As a result, the network can support the metal magnetic particles and suppress their settling.

The content ratio of the additive with respect to the total amount of the silica particles is 50 mass or more and 200 mass % or less, and preferably 80 mass % or more and 120 mass % or less.

When the content ratio of the additive with respect to the total amount of the silica particles is more than or equal to the above lower limit value, the three-dimensional structure formed by the silica particles is enhanced, and the metal magnetic particles having a large volume average particle diameter are less likely to settle.

When the content ratio of the additive with respect to the total amount of silica particles is less than or equal to the above upper limit value, the three-dimensional structure of the silica particles does not develop excessively, and the magnetic fluid composition is less likely to undergo gelation.

The dispersion medium may contain components other than the ionic liquid and the above additive, provided that the effects of the present disclosure are not impaired. Examples of such components include thixotropic agents other than the above additives, surfactants, viscous plastic media, and water-in-oil emulsions.

### Physical Properties of Magnetic Fluid Composition

The magnetic fluid composition has a yield stress of preferably 15 kPa or more and more preferably 20 kPa or more when being applied with a magnetic field of 1.0 T.

A boiling point of the magnetic fluid composition is preferably 250° C. or higher, more preferably 300° C. or higher, and still more preferably 350° C. or higher. The boiling point of the magnetic fluid composition can be measured by a method described in Examples.

A freezing point of the magnetic fluid composition is preferably 0° C. or lower, more preferably-10° C. or lower, and still more preferably −20° C. or lower. The freezing point of the magnetic fluid composition can be measured by a method described in Examples.

The boiling point, freezing point, yield stress, and dispersion stability of the magnetic fluid composition can each be measured by the following methods.

### Method for Measuring Boiling Point

The magnetic fluid composition (2 mL) is heated on a hot plate, a temperature at which white smoke was generated was confirmed and evaluated according to the following criteria. Among the following criteria, when the criteria met A or B, it is evaluated that “the magnetic fluid composition has a high boiling point”.
A: No evaporation up to 350° C.
B: No evaporation up to 250° C.
C: Evaporated below 250° C.

### Method for Measuring Freezing Point

The magnetic fluid composition (2 mL) is cooled by a refrigerator, and a solidification temperature was confirmed and evaluated according to the following criteria. Among the following criteria, when the criteria met A or B, it is evaluated that “the magnetic fluid composition has a low freezing point”.
A: Solidify at −20° C. or lower
B: Solidify more than −20° C. and 0° C. or lower
C: Solidify more than 0° C. and 10° C. or lower

### Method for Measuring Yield Stress

At 250° C., the yield stress of the magnetic fluid composition when being applied with a magnetic field having a shear stress of 333/sec and a magnetic flux density of 1.0 T is measured and evaluated according to the following criteria. Among the following criteria, when the criteria met A or B, it is evaluated that “the magnetic fluid composition has a high braking force”.
A: 20 kPa or more
B: 15 kPa or more and less than 20 kPa
C: 10 kPa or more and less than 15 kPa

### Method for Measuring Dispersion Stability

The yield of stress the magnetic fluid composition is measured immediately after production and after storage at room temperature for one month, and the ratio of the yield stress (immediately after production/after storage) is calculated and evaluated according to the following criteria. Among the following criteria, when the criteria meet A or B, it is evaluated that “the magnetic fluid composition has a high dispersion stability”.
A: 0.9 or more
B: 0.8 or more and less than 0.9
C: less than 0.8

### Method for Producing Magnetic Fluid Composition

The magnetic fluid composition according to the present embodiment can be produced by mixing and stirring the metal magnetic particles, the silica particles, the ionic liquid, and the additive having a polymer or an oligomer with a urea structure in the desired ratio.

### EXAMPLES

### Production of Magnetic Fluid Composition

Magnetic fluid compositions of Examples 1 to 23 and Comparative Examples 1 to 16 were produced by mixing each of the metal magnetic particles, the silica particles, the ionic liquid, and the additive listed in Tables 1 to 6 at the following ratios, followed by stirring under the following conditions.

### Mixing Ratio

Metal magnetic particles: 80 mass %
Silica particles: 1 mass %
Ionic liquid: 19 mass %
Additives: Content ratios are shown in Tables 1 to 6. The additive contents shown in Tables 1 to 6 are defined relative to the total amount of silica particles.

In Tables 1 to 6, the additives refer to the following materials.
BYK-410: Urea-based rheology control agent.
BYK-411: Urea-based rheology control agent
BYK-405: Polyhydroxycarboxylic acid amide-based rheology control agent

### Stirring Conditions

Stirring was performed at 3000 rpm for 30 minutes using a high shear mixer (Silverson, L5M-A).

The boiling point, the freezing point, the yield stress, and the dispersion stability of the magnetic fluid composition were measured and evaluated by the following methods.

### Boiling Point

Measurement was performed by the method described in “Method for Measuring Boiling Point” above.

### Freezing Point

Measurement was performed by the method described in “Method for Measuring Freezing Point” above.

### Yield Stress

Measurement was performed by the method described in “Method for Measuring Yield Stress” above.

### Dispersion Stability

Measurement was performed by the method described in “Method for Measuring Dispersion Stability” above.

TABLE 1

| No. | | Example 1 | | Example 2 | | Example 3 | | Example 4 | |
|---|---|---|---|---|---|---|---|---|---|
| Metal | Magnetic powders | Fe, Si, Cr | | Fe, Si, Cr | | Fe, Si, Cr | | Fe, Si, Cr | |
| Magnetic | Steel grade | Crystal alloy | | Crystal alloy | | Crystal alloy | | Crystal alloy | |
| Particles | Particle diameter | 5 | μm | 5 | μm | 5 | μm | 5 | μm |
| | of magnetic powders | | | | | | | | |
| Ionic Liquid | Types of cations | Ammonium | | Imidazolium | | Imidazolium | | Imidazolium | |
| | Structures of cations | (A)-1-1 | | (B)-1-2 | | (B)-1-2 | | (B)-1-2 | |
| | Anions | Bis(trifluoromethane | | Tetrafluoroboric | | Tetrafluoroboric | | Bis(trifluoromethane | |
| | | sulfonyl)amide | | acid | | acid | | sulfonyl)amide | |
| Silica | Presence or | Present | | Present | | Present | | Present | |
| Particles | absence of silica | | | | | | | | |
| | particles | | | | | | | | |
| | Particle size of | 16 | nm | 16 | nm | 16 | nm | 16 | nm |
| | silica particles | | | | | | | | |
| | Addition amount | 1 | mass % | 1 | mass % | 1 | mass % | 1 | mass % |
| | of silica particles | | | | | | | | |
| Additive | Rheology control | BYK-410 | | BYK-410 | | BYK-411 | | BYK-410 | |
| | agents | | | | | | | | |
| | Addition amount | 100 | mass % | 100 | mass % | 100 | mass % | 100 | mass % |

| | | | | | |
|---|---|---|---|---|---|
| | of rheology | | | | |
| | control agents | | | | |
| Physical | Boiling point | B | B | B | B |
| Properties of | Freezing point | A | A | A | A |
| Magnetic Fluid | Excitation stress | B | B | B | B |
| Compositions | Dispersibility | A | A | A | A |

| No. | | Example 5 | | Example 6 | | Example 7 | |
|---|---|---|---|---|---|---|---|
| Metal | Magnetic powders | Fe, Si, Cr | | Fe, Si, Cr | | Fe, Si, Cr | |
| Magnetic | Steel grade | Crystal alloy | | Crystal alloy | | Crystal alloy | |
| Particles | Particle diameter | 5 | μm | 5 | μm | 20 | μm |

| | | | | |
|---|---|---|---|---|
| | of magnetic powders | | | |
| Ionic Liquid | Types of cations | Ammonium | Imidazolium | Ammonium |
| | | (5-membered ring) | | |
| | Structures of cations | (A)-2-3 | (B)-1-14 | (A)-1-1 |
| | Anions | Bis(trifluoromethane | Tetrafluoroboric | Bis(trifluoromethane |
| | | sulfonyl)amide | acid | sulfonyl)amide |
| Silica | Presence or | Present | Present | Present |
| Particles | absence of silica | | | |
| | particles | | | |

| Particle size of | 16 | nm | 16 | nm | 16 | nm |
|---|---|---|---|---|---|---|
| silica particles | | | | | | |
| Addition amount | 1 | mass % | 1 | mass % | 1 | mass % |

| | | | | |
|---|---|---|---|---|
| | of silica particles | | | |
| Additive | Rheology control | BYK-410 | BYK-410 | BYK-410 |
| | agents | | | |

| | | | | | | |
|---|---|---|---|---|---|---|
| Addition amount | 100 | mass % | 100 | mass % | 100 | mass % |

| | | | | |
|---|---|---|---|---|
| | of rheology | | | |
| | control agents | | | |
| Physical | Boiling point | B | A | B |
| Properties of | Freezing point | A | B | A |
| Magnetic Fluid | Excitation stress | B | B | B |
| Compositions | Dispersibility | A | A | A |

TABLE 2

| No. | | Example 8 | | Example 9 | | Example 10 | | Example 11 | | Example 12 | |
|---|---|---|---|---|---|---|---|---|---|---|---|
| Metal | Magnetic powders | Fe, Co | | Fe, Co | | Fe, Si, Cr | | Fe, Si, Cr | | Fe, Si, Cr | |
| Magnetic | Steel grade | Permendur | | Permendur | | Crystal alloy | | Crystal alloy | | Crystal alloy | |
| Particles | Particle diameter | 5 | μm | 120 | μm | 5 | μm | 5 | μm | 5 | μm |
| | of magnetic | | | | | | | | | | |
| | powders | | | | | | | | | | |
| Ionic | Types of cations | Ammonium | | Ammonium | | Imidazolium | | Pyridinium | | Ammonium | |
| Liquid | Structures of | (A)-1-1 | | (A)-1-1 | | (B)-1-6 | | (C)-1-4 | | (A)-1-1 | |
| | cations | | | | | | | | | | |
| | Anions | Bis(trifluoromethane | | Bis(trifluoromethane | | Trispentanefluoroethyl | | Tetrafluoroboric | | Bis(trifluoromethane | |
| | | sulfonyl)amide | | sulfonyl)amide | | trifluorophosphate | | acid | | sulfonyl)amide | |
| Silica | Presence or | Present | | Present | | Present | | Present | | Present | |
| Particles | absence of silica | | | | | | | | | | |
| | particles | | | | | | | | | | |
| | Particle size of | 16 | nm | 16 | nm | 16 | nm | 16 | nm | 500 | nm |
| | silica particles | | | | | | | | | | |
| | Addition amount | 1 | mass % | 1 | mass % | 1 | mass % | 1 | mass % | 1 | mass % |
| | of silica particles | | | | | | | | | | |
| Additive | Rheology control | BYK-410 | | BYK-410 | | BYK-410 | | BYK-410 | | BYK-410 | |
| | agents | | | | | | | | | | |
| | Addition amount | 100 | mass % | 100 | mass % | 100 | mass % | 100 | mass % | 100 | mass % |

| | | | | | | |
|---|---|---|---|---|---|---|
| | of theology | | | | | |
| | control agents | | | | | |
| Physical | Boiling point | B | B | A | A | B |
| Properties of | Freezing point | A | A | A | A | A |
| Magnetic Fluid | Excitation stress | A | A | B | B | B |
| Compositions | Dispersibility | A | A | A | A | A |

TABLE 3

| No. | | Example 13 | | Example 14 | | Example 15 | | Example 16 | | Example 17 | |
|---|---|---|---|---|---|---|---|---|---|---|---|
| Metal | Magnetic powders | Fe, Si, Cr | | Fe, Si, Cr | | Fe, Si, Cr | | Fe, Si, Cr | | Fe, Si, Cr | |
| Magnetic | Steel grade | Crystal alloy | | Crystal alloy | | Crystal alloy | | Crystal alloy | | Crystal alloy | |
| Particles | Particle diameter | 5 | μm | 5 | μm | 5 | μm | 5 | μm | 5 | μm |
| | of magnetic | | | | | | | | | | |
| | powders | | | | | | | | | | |
| Ionic | Types of | Imidazolium | | Imidazolium | | Imidazolium | | Ammonium | | Ammonium | |
| Liquid | cations | | | | | | | | | (5-membered ring) | |
| | Structures | (B)-1-6 | | (B)-1-6 | | (B)-1-8 | | (A)-1-8 | | (A)-2-4 | |
| | of cations | | | | | | | | | | |
| | Anions | Bis(trifluoromethane | | Hexafluorophosphate | | Hexafluorophosphate | | Bis(trifluoromethane | | Bis(trifluoromethane | |
| | | sulfonyl)amide | | | | | | sulfonyl)amide | | sulfonyl)amide | |
| Silica | Presence or | Present | | Present | | Present | | Present | | Present | |
| Particles | absence of silica | | | | | | | | | | |
| | particles | | | | | | | | | | |
| | Particle size of | 16 | nm | 16 | nm | 16 | nm | 16 | nm | 16 | nm |
| | silica particles | | | | | | | | | | |
| | Addition amount | 1 | mass % | 1 | mass % | 1 | mass % | 1 | mass % | 1 | mass % |
| | of silica particles | | | | | | | | | | |
| Additive | Rheology control | BYK-410 | | BYK-410 | | BYK-410 | | BYK-410 | | BYK-410 | |
| | agents | | | | | | | | | | |
| | Addition amount | 100 | mass % | 100 | mass % | 100 | mass % | 100 | mass % | 100 | mass % |

| | | | | | | |
|---|---|---|---|---|---|---|
| | of theology | | | | | |
| | control agents | | | | | |
| Physical | Boiling point | A | A | A | A | A |
| Properties of | Freezing point | A | A | A | A | A |
| Magnetic Fluid | Excitation stress | B | B | B | B | B |
| Compositions | Dispersibility | A | A | A | A | A |

TABLE 4

| No. | | Example 18 | | Example 19 | | Example 20 | |
|---|---|---|---|---|---|---|---|
| Metal | Magnetic powders | Fe, Si, Cr | | Fe, Si, Cr | | Fe, Si, Cr | |
| Magnetic | Steel grade | Crystal alloy | | Crystal alloy | | Crystal alloy | |
| Particles | Particle diameter of | 5 | μm | 5 | μm | 5 | μm |
| | magnetic powders | | | | | | |
| Ionic | Types of | Ammonium | | Pyridinium | | Pyridinium | |
| Liquid | cations | (5-membered ring) | | | | | |
| | Structures of cations | (A)-2-4 | | (B)-1-6 | | (B)-1-6 | |
| | Anions | Trispentanefluoroethyl | | Tetrafluoroboric | | Bis(trifluoromethane | |
| | | trifluorophosphate | | acid | | sulfonyl)amide | |
| Silica | Presence or absence of | Present | | Present | | Present | |
| Particles | silica particles | | | | | | |
| | Particle size of | 16 | nm | 16 | nm | 16 | nm |
| | silica particles | | | | | | |
| | Addition amount of | 1 | mass % | 1 | mass % | 1 | mass % |
| | silica particles | | | | | | |
| Additive | Rheology control agents | BYK-410 | | BYK-410 | | BYK-410 | |
| | Addition amount of | 100 | mass % | 100 | mass % | 100 | mass % |

| | | | | |
|---|---|---|---|---|
| | rheology control agents | | | |
| Physical | Boiling point | A | A | A |
| Properties of | Freezing point | A | A | A |
| Magnetic Fluid | Excitation stress | B | B | B |
| Compositions | Dispersibility | A | A | A |

| No. | | Example 21 | | Example 22 | | Example 23 | |
|---|---|---|---|---|---|---|---|
| Metal | Magnetic powders | Fe, Si, Cr | | Fe, Co | | Fe, Co | |
| Magnetic | Steel grade | Crystal alloy | | Permendur | | Permendur | |
| Particles | Particle diameter of | 5 | μm | 5 | μm | 120 | μm |
| | magnetic powders | | | | | | |
| Ionic | Types of | Phosphonium | | Phosphonium | | Phosphonium | |
| Liquid | cations | | | | | | |
| | Structures of cations | (D)-1 | | (D)-1 | | (D)-1 | |
| | Anions | Bis(trifluoromethane | | Bis(trifluoromethane | | Bis(trifluoromethane | |
| | | sulfonyl)amide | | sulfonyl)amide | | sulfonyl)amide | |
| Silica | Presence or absence of | Prosent | | Present | | Present | |
| Particles | silica particles | | | | | | |
| | Particle size of | 16 | nm | 16 | nm | 16 | nm |
| | silica particles | | | | | | |
| | Addition amount of | 1 | mass % | 1 | mass % | 1 | mass % |
| | silica particles | | | | | | |
| Additive | Rheology control agents | BYK-410 | | BYK-410 | | BYK-410 | |
| | Addition amount of | 100 | mass % | 100 | mass % | 100 | mass % |

| | | | | |
|---|---|---|---|---|
| | rheology control agents | | | |
| Physical | Boiling point | A | A | A |
| Properties of | Freezing point | A | A | A |
| Magnetic Fluid | Excitation stress | B | A | A |
| Compositions | Dispersibility | A | A | A |

TABLE 5

| | | Comparative | | Comparative | | Comparative. | | Comparative | |
|---|---|---|---|---|---|---|---|---|---|
| No. | | Example 1 | | Example 2 | | Example 3 | | Example 4 | |
| Metal | Magnetic powders | Fe, Si, Cr | | Fe, Si, Cr | | Fe, Si, Cr | | Fe, Si, Cr | |
| Magnetic | Steel grade | Crystal alloy | | Crystal alloy | | Crystal alloy | | Crystal alloy | |
| Particles | Particle diameter of | 5 | μm | 5 | μm | 5 | μm | 5 | μm |
| | magnetic powders | | | | | | | | |
| Ionic | Types of cations | Hydrocarbon | | Imidazolium | | Imidazolium | | Imidazolium | |
| Liquid | Structures of cations | oil | | (B)1-8 | | (B)-1-2 | | (B)-1-2 | |
| | Anions | | | Hexafluorophosphate | | Bis(trifluoromethane | | Bis(trifluoromethane | |
| | | | | | | sulfonyl)amide | | sulfonyl)amide | |
| Silica | Presence or | Present | | Present | | Absent/molybdenum | | Present | |
| Particles | absence of | | | | | disulfide added | | | |
| | silica particles | | | | | | | | |
| | Particle size of | 16 | nm | 16 | nm | 1400 | nm | 7 | nm |
| | silica particles | | | | | | | | |
| | Addition amount of | 1 | mass % | 1 | mass % | 1 | mass % | 1 | mass % |

| | | | | | |
|---|---|---|---|---|---|
| | silica particles | | | | |
| Additive | Rheology control | No | No | No | No |
| | agents | | | | |
| | Addition amount of | | | | |
| | theology control | | | | |
| | agents | | | | |
| Physical | Boiling point | C | A | B | B |
| Properties of | Freezing point | B | A | A | A |
| Magnetic Fluid | Excitation stress | C | C | C | C |
| Compositions | Dispersibility | C | B | C | C |

| | | Comparative | | Comparative | | Comparative | | Comparative | |
|---|---|---|---|---|---|---|---|---|---|
| No. | | Example 5 | | Example 6 | | Example 7 | | Example 8 | |
| Metal | Magnetic powders | Fe, Si, Cr | | Fe, Si, Cr | | Fe, Si, Cr | | Fe, Si, Cr | |
| Magnetic | Steel grade | Crystal alloy | | Crystal alloy | | Crystal alloy | | Crystal alloy | |
| Particles | Particle diameter of | 5 | μm | 5 | μm | 5 | μm | 5 | μm |

| | | | | | |
|---|---|---|---|---|---|
| | magnetic powders | | | | |
| Ionic | Types of cations | Ammonium | Imidazolium | Imidazolium | Pyridinium |
| Liquid | Structures of cations | (A)-1-8 | (B)-1-1 | (B)1-16 | (C)-1-4 |
| | Anions | Trifluoromethane | Trifluoromethane | Chloride | Bromide |
| | | sulfonic acid | sulfonic acid | | |
| Silica | Presence or | Present | Present | Present | Present |
| Particles | absence of | | | | |
| | silica particles | | | | |

| Particle size of | 16 | nm | 16 | nm | 16 | nm | 16 | nm |
|---|---|---|---|---|---|---|---|---|
| silica particles | | | | | | | | |
| Addition amount of | 1 | mass % | 1 | mass % | 1 | mass % | 1 | mass % |

| | | | | | |
|---|---|---|---|---|---|
| | silica particles | | | | |
| Additive | Rheology control | No | No | No | No |
| | agents | | | | |
| | Addition amount of | | | | |
| | theology control | | | | |
| | agents | | | | |
| Physical | Boiling point | C | A | C | B |
| Properties of | Freezing point | C | C | C | C |
| Magnetic Fluid | Excitation stress | B | B | B | B |
| Compositions | Dispersibility | B | B | B | B |

TABLE 6

| | | Comparative | | Comparative | | Comparative | | Comparative | |
|---|---|---|---|---|---|---|---|---|---|
| No. | | Example 9 | | Example 10 | | Example 11 | | Example 12 | |
| Metal | Magnetic powders | Fe, Si, Cr | | Fe, Si, Cr | | Fe, Co | | Fe, Co | |
| Magnetic | Steel grade | Crystal alloy | | Crystal alloy | | Permendur | | Permendur | |
| Particles | Particle diameter of | 3 | μm | 150 | μm | 3 | μm | 150 | μm |
| | magnetic powders | | | | | | | | |
| Ionic | Types of cations | Imidazolium | | Imidazolium | | Imidazolium | | imidazolium | |
| Liquid | Structures of cations | (B)-1-2 | | (B)-1-2 | | (B)-1-2 | | (B)-1-2 | |
| | Anions | Bis(trifluoromethane | | Bis(trifluoromethane | | Bis(trifluoromethane | | Bis(trifluoromethane | |
| | | sulfonyl)amide | | sulfonyl)amide | | sulfonyl)amide | | sulfonyl)amide | |
| Silica | Presence or absence | Present | | Present | | Present | | Present | |
| Particles | of silica particles | | | | | | | | |
| | Particle size of | 16 | nm | 16 | nm | 16 | nm | 16 | nm |
| | silica particles | | | | | | | | |
| | Addition amount of | 1 | mass % | 1 | mass % | 1 | mass % | 1 | mass % |

| | | | | | |
|---|---|---|---|---|---|
| | silica particles | | | | |
| Additive | Rheology control | No | No | No | No |
| | agents | | | | |
| | Addition amount of | | | | |
| | theology control | | | | |
| | agents | | | | |
| Physical | Boiling point | B | B | B | B |
| Properties of | Freezing point | A | A | A | A |
| Magnetic Fluid | Excitation stress | C | C | C | C |
| Compositions | Dispersibility | B | C | B | C |

| | | Comparative | | Comparative | | Comparative | | Comparative | |
|---|---|---|---|---|---|---|---|---|---|
| No. | | Example 13 | | Example 14 | | Example 15 | | Example 16 | |
| Metal | Magnetic powders | Fe, Si, Cr | | Fe, Si, Cr | | Fe, Si, Cr | | Fe, Si, Cr | |
| Magnetic | Steel grade | Crystal alloy | | Crystal alloy | | Crystal alloy | | Crystal alloy | |
| Particles | Particle diameter of | 5 | μm | 5 | μm | 5 | μm | 5 | μm |

| | | | | | |
|---|---|---|---|---|---|
| | magnetic powders | | | | |
| Ionic | Types of cations | Hydrocarbon | Imidazolium | Imidazolium | Imidazolium |
| Liquid | Structures of cations | oil | (B)-1-2 | (B)-1-2 | (B)-1-2 |
| | Anions | | Tetrafluoroboric | Tetrafluoroboric | Tetrafluoroboric |
| | | | acid | acid | acid |
| Silica | Presence or absence | Present | Present | Present | Present |
| Particles | of silica particles | | | | |

| Particle size of | 16 | nm | 16 | nm | 16 | nm | 16 | nm |
|---|---|---|---|---|---|---|---|---|
| silica particles | | | | | | | | |
| Addition amount of | 1 | mass % | 1 | mass % | 1 | mass % | 1 | mass % |

| | | | | | |
|---|---|---|---|---|---|
| | silica particles | | | | |
| Additive | Rheology control | BYK-410 | BYK-410 | BYK-410 | BYK-405 |
| | agents | | | | |

| | | | | | | | | |
|---|---|---|---|---|---|---|---|---|
| Addition amount of | 100 | mass % | 48 | mass % | 210 | mass % | 100 | mass % |

| | | | | | |
|---|---|---|---|---|---|
| | theology control | | | | |
| | agents | | | | |
| Physical | Boiling point | C | B | B | B |
| Properties of | Freezing point | B | A | A | A |
| Magnetic Fluid | Excitation stress | C | B | B | B |
| Compositions | Dispersibility | A | C | C | C |

In Tables 1 to 6, the structures of the cations are shown below.

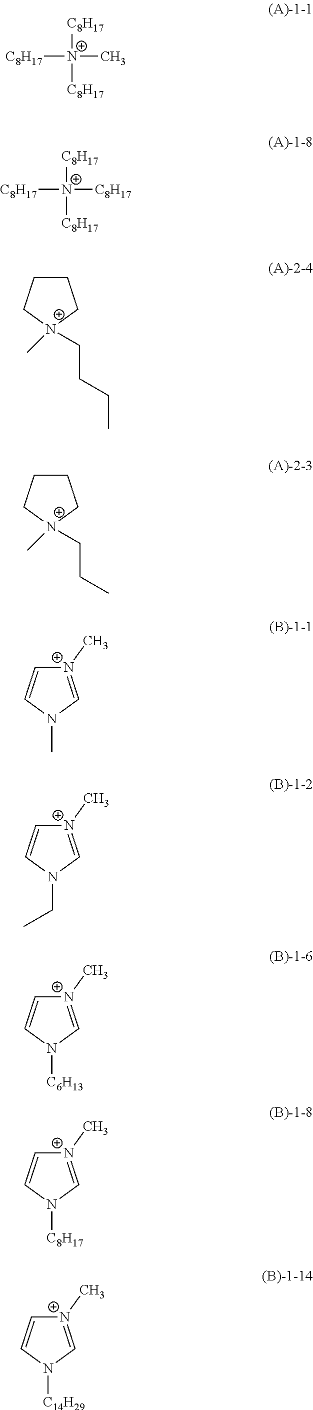

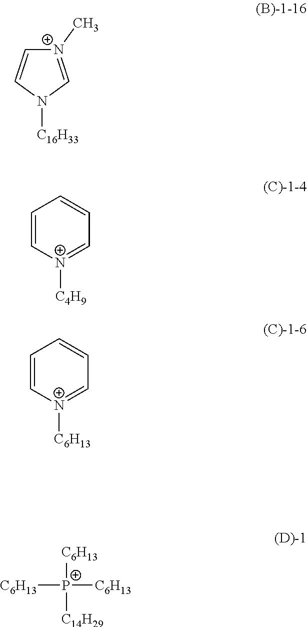

As described in the above results, in Examples 1 to 23, the yield stress was all A or B, and it was confirmed that a high braking force can be achieved. Furthermore, in Examples 1 to 23, it was confirmed that all the results of dispersion stability were A or B, and the dispersion stability was excellent. This is considered to be because the three-dimensional structure formed by the silica particles constituting the dispersion medium was enhanced by the additives, and the metal magnetic particles having a large volume average particle diameter were less likely to settle. Therefore, it was confirmed that the magnetic fluid composition of Examples 1 to 23 can achieve both high braking force and dispersion stability.

In Comparative Examples 1 and 13 in which the ionic liquid was not used in the dispersion medium but a hydrocarbon oil was used, it was considered that the affinity between the metal magnetic particles and the dispersion medium is insufficient, and the yield stress is insufficient because the magnetic fluid composition was separated.

In Comparative Examples 3, 4, 10, and 12, in which the additive does not contain a polymer or oligomer having a urea structure, it was considered that the metal magnetic particles settle and the yield stress is insufficient because the magnetic fluid composition was separated.

In Comparative Example 14, in which the blending amount of the additive was 0.48 mass %, the three-dimensional structure formed by the silica particles was insufficiently developed due to the low amount of additive, and the metal magnetic particles having a large volume average particle diameter settled.

In Comparative Example 14, in which the blending amount of the additive was 2.1 mass %, the three-dimensional structure formed by the silica particles was excessively developed due to the high amount of additive, and the magnetic fluid composition is considered to have undergone gelation.

In Comparative Example 16, in which a polyhydroxycarboxylic acid amide-based rheology control agent was used, the dispersibility was rated as C. This is likely because, with the polyhydroxycarboxylic acid amide-based rheology control agent, the three-dimensional network formed by the silica particles was excessively developed, resulting in gelation of the magnetic fluid composition.

What is claimed is:

1. A magnetic fluid composition comprising: a dispersoid and a dispersion medium,
wherein the dispersoid contains metal magnetic particles having an average particle diameter of 5 μm or more and 120 μm or less and silica particles having an average particle diameter of 10 nm or more and 500 nm or less;
the dispersion medium contains an ionic liquid and an additive containing a polymer or oligomer having a urea structure;
the content ratio of the silica particles with respect to a total amount of the magnetic fluid composition is 0.01 mass % or more and 5 mass % or less; and
the content ratio of the additive with respect to a total amount of the silica particles is 50 mass % or more and 200 mass % or less.

2. The magnetic fluid composition according to claim 1, wherein the ionic liquid contains a cationic group and an anionic group, the cationic group is one or more selected from the group including a quaternary ammonium ion, an imidazolium ion, a pyridinium ion, and a phosphonium ion, and
the anionic group is one or more selected from the group including a tetrafluoroborate ion, a hexafluorophosphate ion, a trispentafluoroethyltrifluorophosphate ion, and a bis(trifluoromethanesulfonyl)amide ion.

3. The magnetic fluid composition according to claim 2, wherein
the cationic group is a cation of any of the following (A)-1, (A)-2, (B)-1, (C)-1, and (D)-1: 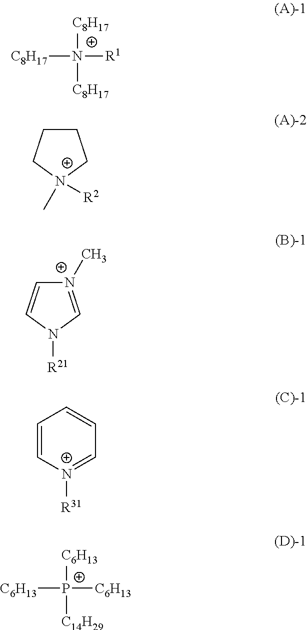
[In the above formula, R¹ represents a linear or branched alkyl group having 1 to 10 carbon atoms, R² represents a linear or branched alkyl group having 1 to 5 carbon atoms, R²¹ represents an alkyl group having 4 to 6 carbon atoms, and R³¹ represents an alkyl group having 4 to 8 carbon atoms.]

4. The magnetic fluid composition according to claim 1, wherein the material of the metal magnetic particles is permendur.

5. The magnetic fluid composition according to claim 1, wherein
the magnetic fluid composition has a yield stress of 15 kPa or more when being applied with a magnetic field of 1.0 T.

6. The magnetic fluid composition according to claim 1, wherein
the magnetic fluid composition has a boiling point of 250° C. or higher and a freezing point of 0° C. or lower.
